(19) United States
(12) Patent Application Publication
(10) Pub. No.: US 2013/0295227 A1
(43) Pub. Date: Nov. 7, 2013

(54) Composition Comprising a Sensitive Ingredient

(71) Applicants: Robbert H. Ter Haar, Lebanon, OH (US); Gregory Dean Sunvold, Lewisburg, OH (US); Monika Barbara Horgan, Oxford, OH (US); Lawrence Andrew Schumacher, Trenton, OH (US)

(72) Inventors: Robbert H. Ter Haar, Lebanon, OH (US); Gregory Dean Sunvold, Lewisburg, OH (US); Monika Barbara Horgan, Oxford, OH (US); Lawrence Andrew Schumacher, Trenton, OH (US)

(21) Appl. No.: 13/460,989

(22) Filed: May 1, 2012

(51) Int. Cl. A23K 1/16; B65D 85/00

(52) U.S. Cl. 426/61; 426/89

(57) ABSTRACT

A composition having from 45% to 90%, by weight, of a first portion and from 10% to 55%, by weight, a second portion. The first portion has a lower melting point than the second portion. The first portion can have a higher water activity than the second portion. The first portion contains a sensitive ingredient which can be a Probiotic. The composition can be a supplement intended to be given to a pet.

### FIELD OF INVENTION

The present invention relates to compositions, more specifically supplements that contain a sensitive ingredient.

### BACKGROUND OF THE INVENTION

The present invention relates to compositions, such as supplements that can be fed to a pet. The compositions can contain sensitive ingredients. One problem with manufacturing compositions that contain sensitive ingredients is that sensitive ingredients are often susceptible to heat and moisture. Consumers have no easy way to know whether the sensitive ingredient in a composition has been exposed to excessive heat or moisture, which can compromise the sensitive ingredient. Therefore, consumers can use a composition or administer a composition that does not contain the full health benefits that they were anticipating.

The compositions of the present invention can have two portions, each with a different melting point. This can help improve the aesthetics of the composition. For instance, if the first portion melts and the second portion has a higher melting point, the second portion can assist in helping the first portion to resolidify into approximately its original shape.

The melting points can also provide a visual indicator of whether or not the sensitive ingredient has been compromised. The composition can be designed so the melting point of the second portion is greater than or equal to the temperature at which the sensitive ingredient is compromised. Therefore, if a consumer opens a package and the composition appears melted, partially melted or deformed, the consumer will know that the sensitive ingredient may be compromised.

The compositions of the present invention can also help control moisture. The two portions of the present invention can have different water activities. In one example, the water activity of the second portion is lower than the water activity of the first portion. Many sensitive ingredients, including Probiotic microorganisms, are sensitive to moisture and the different water activities encourage moisture to migrate towards the portion with the lower water activity.

As such, there remains a need for a composition that provides a visual indicator as to whether the sensitive ingredient is compromised, controls the moisture content, and is aesthetically appealing.

### SUMMARY OF THE INVENTION

A composition comprising: (a) from 45% to 90%, by weight, of a first portion wherein the first portion comprises a sensitive ingredient and wherein the first portion has a first melting point; and (b) from 10% to 55%, by weight, of a second portion wherein the second portion has a second melting point and wherein the second melting point is greater than the first melting point.

### BRIEF DESCRIPTION OF THE DRAWINGS

While the specification concludes with claims particularly pointing out and distinctly claiming the subject matter of the present invention, it is believed that the invention can be more readily understood from the following description taken in connection with the accompanying drawings, in which:

FIG. 1 is a perspective view of an example of the composition;

FIG. 2 is a perspective view of a primary package;

FIG. 2A is a cross-section view of FIG. 2.

### DETAILED DESCRIPTION OF THE INVENTION

The present invention relates to a composition with a first portion, a second portion, and a sensitive ingredient. The second portion can have a different melting point than the first portion. The different melting points can help improve the aesthetics of the composition and in some examples can provide a simple visual indicator as to whether or not the probiotics have been compromised. In one example, the melting points can differ by 5 degrees Fahrenheit (F).

The melting point difference can also assist as follows. In one example, the first portion can contain the sensitive ingredient and has a melting point that is 5° F. lower than the second portion. The second portion can partially or completely cover the second portion. If the first portion is exposed to conditions that cause it to melt or partially melt, the second portion, which can have a higher melting point, can assist in allowing the first portion to resolidify into approximately its original shape. If the composition is enclosed within a package, like a blister package as disclosed herein, the second portion can keep the first portion in its desired shape since the second portion remains solid and once the temperature has decreased, the first portion can resolidify into its initial shape. In one example, the second portion can be formulated so the melting point is greater than or equal to the temperature where the sensitive ingredient is compromised. Therefore, if the second portion is partially or completely melted or is otherwise deformed then the consumer knows that the sensitive ingredient has been compromised and the composition may not provide the benefits that the consumer was anticipating.

In one example, the water activity and the water content of the second portion can be lower than the first portion. In this example the moisture migration is typically towards the second portion and away from the first portion, which can be especially advantageous if the second portion is substantially free of a sensitive ingredient while the first portion comprises a sensitive ingredient.

As used herein, the term “adapted for use” means that the pet food products described can meet the American Association of Feed Control Officials (AAFCO) safety requirements for providing pet food products for a pet as may be amended from time to time.

As used herein, the term “compromised” means that the sensitive ingredient is significantly damaged or killed. With respect to probiotics, compromised means that the probiotic is not viable. In one example, compromised means that more than 25% of the probiotics are no longer viable, in another example more than 40% of the probitoics are no longer viable, in another example more than 50% of the probiotics are no longer viable, in another example more than 60% of the probiotics are no longer viable, in another example more than 75% of the probiotics are no longer viable, in another example more than 85% of the probiotics are no longer vialbe, and in another example more than 95% of the probiotics are no longer viable.

As used herein, the term “pet” means a domestic animal, also referred to herein as a companion animal, including, but not limited to, domestic dogs (canines), cats (felines), horses, cows, ferrets, rabbits, pigs, and the like.

As used herein, the term “plurality” means more than one.

As used herein, the term “portion” means a chemically or physically discrete section within the entire composition. A portion does not include microscopic sections. In one example a portion is greater than 3% by weight of the composition, in another example greater than 5% by weight, in another example greater than 10% by weight, in another example greater than 15% by weight, in another example greater than 20% by weight, and in another example greater than 25% by weight. In one example, the composition comprises two portions and each portion is a layers.

As used herein, the term “layer” means a portion covering a surface or forming an overlying part or segment.

As used herein, the term “supplement” means a form of an ingestible composition, such as a tablet, capsule, which can be gelatin, or the like, or other forms such as biscuits, chews, edible films, gels, pills, or other treats, which are intended to be used not as entire meals but in addition to regularly consumed food meals, and typically, but not always, are meant to provide a health benefit above and beyond that of the regularly consumed food meals.

As used herein, the term “substantially free of means not intentionally adding and typically means having less than an amount of a particular component such that one of ordinary skill in the art would not consider that amount to provide a health benefit. In one example substantially free means less than 0.0001%, alternatively less than 0.001%, alternatively less than 0.01%, alternatively less than 0.1%, alternatively less than 0.05%, alternatively less than 0.01%, all by weight of the composition.

As used herein, the term “sensitive ingredient” means an ingredient that is sensitive to humidity, oxygen or air, and/or heat.

As used herein, the term “thick” or “thickness” means the distance from one surface to the opposite, in the solidified composition's smallest dimension.

As used herein, the term “viable Probiotic microorganism” means a Probiotic microorganism in its live state, which by definition herein also includes, but is not limited to, those in the dormant state and spores but can also include non-spore formers.

As used herein, the term “water activity” means the vapor pressure of water above a sample, such as a composition described herein, divided by that of pure water at the same temperature and generally refers to the amount of free water available to participate in chemical reactions. Water activity is often times represented by the mathematical equation a_{w}=p/p₀, where p is the vapor pressure of water in the sample, and p₀ is the vapor pressure of pure water at the same temperature.

Water activity can be measured by using the AquaLab Series 4TE water activity meter (available from Decagon Devices, Inc., Pullman, Wash.). First, the water activity meter is turned on and allowed to warm-up for 30 minutes. Prior to running the test composition, a system check is performed by running three verification standards that are purchased in single use vials and are available from Decagon Devices Inc. The first verification standard is 8.57 M LiCl and a_{w}=0.500±0.003 at 77° F. (25° C.), the second verification standard is 6.0 M NaCl and a_{w}=0.760±0.003 at 77° F. (25° C.), and the third verification standard is distilled water and a_{w}=1.000±0.003 a_{w} at 77° F. (25° C.). For the standards, open vial and add the contents to a 15 ml disposable sample cup, which is available from Decagon Devices. If the reading is not within +/−0.003 of what the standard measurement is, then the water activity meter needs to be cleaned and the sample needs to be re-run. If the sample still does not fall within the +/−0.003 of what the standard measurement is, then refer to the Decagon manual for troubleshooting and further cleaning instructions. Do not proceed with the water activity test for the test composition until the system check is complete. To test the test composition grind the test composition and place it in the sample cup. There needs to be enough ground test composition to just cover the bottom of the sample cup. Place the test composition in the sample well and close the drawer, then turn the knob on the water activity meter and the analysis will begin.

As used herein, the articles including “the”, “a”, and “an”, when used in a claim or in the specification, are understood to mean one or more of what is claimed or described.

As used herein, the terms “include”, “includes”, and “including” are meant to be non-limiting.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The composition and methods of the present invention can comprise, consist of, or consist essentially of, the essential elements and limitations of the invention described herein, as well as any additional or optional ingredients, components, or limitations described herein or otherwise useful in compositions intended for pet consumption.

The sensitive ingredients useful herein may be categorized or described herein by their health benefit and/or health conditions or their postulated mode of action or function. However, it is to be understood that the sensitive ingredients can, in some instances, provide more than one health benefit and/or health condition or function or operate via more than one mode of action. Therefore, classifications herein are made for the sake of convenience and are not intended to limit an ingredient to the particularly stated function(s) or activities listed.

In the description of the various embodiments of the present disclosure, various embodiments or individual features are disclosed. As will be apparent to the ordinarily skilled practitioner, all combinations of such embodiments and features are possible and can result in preferred executions of the present disclosure. While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

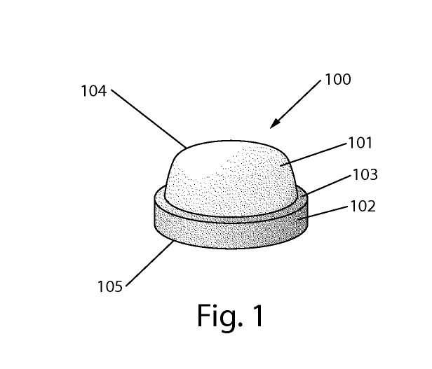

FIG. 1 represents one example of composition 100. Composition 100 comprises a first portion 101 comprising the sensitive ingredient adjacent to a second portion 102 comprising a fat, as indicated by the separate portions. The first portion 101 and the second portion 102 are discussed more fully hereafter. The first portion has a surface 104 and the second portion has a surface 105. In the figure, the first portion 101 and the second portion 102 form the composition 100. The first portion 101 can meet the second portion 102 at interface 103 such that the second portion 102 substantially covers the first portion 101 at the interface 103. As the figure depicts, each of the first portion 101 and the second portion 102 are at least partially exposed to the environment when removed from the mold; that is, with relation to the supplement as shown in its final form, each of the first portion 101 and the second portion 102 is visible or visibly apparent such that each has a surface that is exposed or at least partially exposed. Thus, one portion is not completely surrounded by another portion such that the surrounded portion is not visible. Therefore, in one embodiment, first portion 101 and second portion 102 are each individually exposed and thus visible and discernible. However, in another example one of the portions could completely surround the other portions, such as a filling. In one example, the first portion and the second portion are substantially non-mixed. In another example, the first portion and the second portion are adjacent to one another.

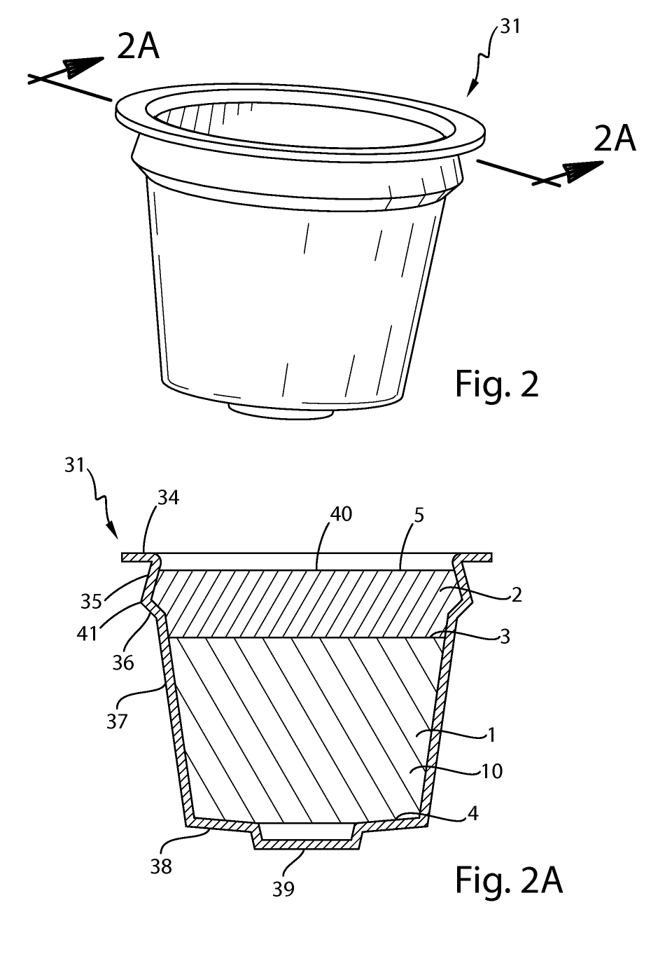

An example of an enclosure is depicted in FIG. 2. In one example, the enclosure 31 is part of a blister pack that contains multiple individual blister enclosures.

A cross-section of the enclosure of FIG. 2, along line 2A, is depicted in FIG. 2A. Enclosure 31, as shown, can be circular. Enclosure 31 can include lip 34. Lip 34 can end at surface 35. Surface 35 can extend outwards from the interior of the enclosure. Surface 36 can extend inward from surface 35 towards the interior of the enclosure and surface 35 and surface 36 form a forming a slight v-shape. Surface 36 can then extend downward and lessen its angle with the vertical, forming body surface 37. Body surface 37 can form the main body of the supplement. Body surface 37 can then continue downward and end at bottom surface 38. Bottom surface 38 can form the top of the supplement and thus feature surface 39 can be used to include indicia and/or be made into a shape, such as a paw print, to the top of the supplement. Of course, feature surface 39 can be of any shape or size, as is described herein. In this configuration, the bottom surface 38 and the body surface 37 define an interior volume for the supplement.

Fill line 40 can represent the height of a mixture or a finished supplement when filled or hardened in the enclosure 31. Enclosure 31 contains composition 10 which comprises a first portion 1 comprising the sensitive ingredient adjacent to a second portion 2 comprising a fat, as indicated by the separate portions. The first portion 1 has a surface 4 and the second portion 2 has a surface 5. The first portion 1 can meet the second portion 2 at interface 3 such that the second portion 2 substantially covers the first portion 1 at the interface 3.

It can be advantageous for the finished supplement to fill the enclosure to fill line 40. In one example, the mixture that forms the supplement can be filled into enclosure 31. Once filled, the mixture can harden while in the enclosure, and thus can take the shape of the enclosure. After the supplement has hardened, it does not always fit snugly in enclosure 31. For instance, in some examples, the supplement can shrink when it hardens and when the packaging or supplement is disturbed the supplement can be jostled from its original fit in enclosure 31. One problem with jostling the supplement, is that it could break.

Surfaces 35 and 36 can together define a frill, which can help mitigate or prevent jostling of the supplement. In one example, the frill formed by surfaces 35 and 36 can form a v-shape and the fill line 40, which marks the top of the composition 10, is above the transition point 41 between surfaces 35 and 36. The diameter of the transition point 41 can be greater than the diameter of the fill line 40, thus surface 35 can act as a stopper to prevent the supplement from falling out of the enclosure 31. Such a feature can be extremely advantageous when enclosures are used as both a mold and a holding/shipping/delivery vehicle. The frill has a draft angle with a maximum of angle of 5°, which is large enough to prevent jostling but small enough to still allow the composition to be easily removed. The fill line 40 can represent the height of the composition and surface 5. In one example, fill line 40 can be above transition point 41, in another example fill line 40 can be below transition point 41 and in another example fill line 40 is at transition point 41.

Feature surface 39 can form a surface exterior to that of bottom surface 38. When enclosure 31 is an enclosure as part of a blister pack, feature surface 39 can serve many purposes. For example, when feature surface 39 forms a surface exterior to that of bottom surface 38, it can allow a consumer an easier way to push out the supplement out of the enclosure and through any seal that can be present.

In one example, the composition is a supplement. In another example, the composition is not a tablet which means that the composition is not a fine powder material that is compacted into a tablet. In another example, the composition is not a capsule. And in another example, the composition is not a nutritionally balanced pet food.

The composition can comprise from 1% to 99%, by weight, of a first portion and from 1% to 99%, by weight, second portion. All ranges there between are envisioned. In another example, the composition can comprise from 50% to 99%, by weight, first portion and from 1% to 50%, by weight, second portion; in another example, from 45% to 90%, by weight, first portion and from 10% to 55%, by weight, second portion; in another example, from 45% to 80%, by weight, first portion and from 20% to 55%, by weight, second portion; in another example, from 40% to 80%, by weight, first portion and from 20% to 60%, by weight, second portion; in another example, from 50% to 70%, by weight, first portion and from 30% to 50%, by weight, second portion; in another example, from 55% to 65%, by weight, first portion and from 35% to 45%, by weight, second portion; and in another example, 75%, by weight, first portion and 25%, by weight, second portion.

The composition can have a weight ratio of first portion to second portion from 99:1 to 1:1, in another example from 50:1 to 3:2, in another example from 20:1 to 5:4; in another example from 15:1 to 2:1, in another example from 12:1 to 5:2, in another example from 10:1 to 14:5, and in another example from 5:1 to 3:1. In one example the ratio of first portion to second portion is 3:1.

In one example, the second portion does not completely surround the first portion. This can simplify manufacturing by allowing the composition to be formed while both the first portion and the second portion are liquid components. In one example, the composition is formed in a mold and the mold is first filled with the first portion and then the second portion, where the first portion and the second portion can both be liquid. In one example, the mold is the container that the individual compositions or multiple compositions are shipped and/or sold in.

In one example the second portion covers from 10% to 100% of the surface of the first portion, in another example from 10% to 80% of the surface of the first portion, in another example from 10% to 70% of the surface of the first portion, in another example from 10% to 60% of the surface of the first portion, in another example from 10% to 50% of the surface of the first portion, in another example from 10% to 40% of the surface of the first portion, in another example from 10% to 30% of the surface of the first portion, in another example from 10% to 25% of the surface of the first portion, and in another example from 10% to 20% of the surface of the first portion.

In one example the first portion is a shaped like a hemisphere and the flat side is partially or substantially covered by the second portion. In another example the first portion is shaped like a prism (i.e. a triangular prism, a square prism, a pentagonal prism, a hexagonal prism, etc.) and one side is partially or substantially covered by the second portion, in another example at least one side is partially or substantially covered by the second portion, in another example at least two sides are partially or substantially covered by the second portion, in another example at least three sides are partially or substantially covered by the second portion, and in another example at least four sides are partially or substantially covered by the second portion.

Compositionally the first and second portion can be different.

The first portion can comprise a fat, a sweetener, a sensitive ingredient, and/or a colorant. In one example, the sensitive ingredient in the first portion can be a Probiotic. In one example, the fat is a cocoa butter component. In one example, the first portion can comprise a sensitive ingredient, a cocoa butter component, a sweetener component, and a colorant.

The first portion can comprise from 0.01% to 40%, by weight, fat. In another example, the first portion can comprise from 0.01% to 20%, by weight, fat component. In another example, the first portion can comprise from 0.01% to 10%, by weight, fat component. In another example, the first portion can comprise from 0.01% to 1%, by weight, fat component. In one example, the fat can be a high melting fat, such as those manufactured by Paramount™ and Loders™, such as palm kernel oil.

The first portion can comprise from 25% to 95%, by weight, sweetener, in another example from 30% to 85%, in another example from 35% to 65%, in another example, from 40% to 60%, by weight, sweetener, in another example from 40% to 50%, and in another example from 42% to 48%. In one example, the sweetener can be a sweetener component and the sweetener component can be a creamy white coating, as described hereafter.

In one example, the first portion can have a first melting point. In one example, the first melting point can be above 85° F., in another example from 100° F. to 105° F., in another example up to 120° F. In another example, the first melting point can be at least 5° F. lower than the second melting point.

In one example, the water activity of the first portion can be between 0.1 and 0.4, or between 0.2 and 0.31, or less than 0.3. In one example, no water has been intentionally added to the first portion.

The second portion can comprise a fat, a sweetener, a processing aid, a sensitive ingredient, and/or a colorant. In one example, the second portion is substantially free of a sensitive ingredient. In another example, the second portion is substantially free of a Probiotic. In one example, the second portion can consist of a fat, a sweetener, a processing aid, and a colorant.

The second portion can comprise from 10% to 50%, by weight, fat, in another example from 20% to 50%, by weight, fat, in another example, from 30% to 40%, by weight, fat. In another example, the second portion can comprise 35%, by weight, fat. In one example, the fat can be partially hydrogenated vegetable oil, which can include cotton seed oil, soybean oil, palm kernel oil, and combinations thereof. In one example, the fat can comprise hydrogenated palm oil. In one example, the second portion can comprise one hydrogenated fat and one non-hydrogenated fat. In one example, the non-hydrogenated fat is tallow. In another example, the fat can be partially hydrogenated palm kernel oil. In one example, the fat can be a K.L.X.™ high melting point fat (available from Loders Croklaan, Wormerveer, The Netherlands) with a melting point of 127° F. In another example, the fat can be Paramount B (available from Loders Croklaan, Wormerveer, The Netherlands) with a melting point of 97° F. And in another example the vegetable oil can be Freedom 905 (available from Loders Croklaan, Wormerveer, The Netherlands) with a melting point of 95° F. In another example, the fat can be 27 Stearine (available from Loders Croklaan, Wormerveer, The Netherlands) with a melting point of 140° F.

The second portion can comprise from 20% to 99%, by weight, sweetener component. In another example, the second portion can comprise from 20% to 90%, by weight, sweetener. In another example, the second portion can comprise from 30% to 80%, by weight, sweetener. In another example, the second portion can comprise from 50% to 70%, by weight, sweetener. In another example, the second portion can comprise from 60% to 70%, by weight, sweetener. Non-limiting examples of sweeteners can include polyols such as glycerol, sorbitol (E420), and xylitol maltitol (E965), polymeric polyols like polydextrose (E1200), or natural extracts like quillaia (E999), lactic acid, or urea. In one example, the sweetener is 6× refined sugar. 6× refined sugar can be used to impart superior mouth-feel and the palatability of the composition as well as improving the flowability of the mixture during processing.

The second portion can comprise from 0% to 5%, by weight, processing aid. In another example, the second portion can comprise from 0% to 4%, by weight, processing aid. In another example, the second portion can comprise from 0% to 2%, by weight, processing aid. In another example, the second portion can comprise 1%, by weight, processing aid. In one example, the processing aid can be lecithin.

The second portion can further comprise a humectant. A humectant can be used to draw moisture away from the first portion, where the sensitive ingredient can be located, and bind the moisture so that it assists in keeping moisture away from the sensitive ingredient. Non-limiting examples of humectants can include propylene glycol (E1520), glyceryl triacetate (E1518), vinyl alcohol, neoagarobiose, glycerin, and combinations thereof.

In one example, the second portion can have a second melting point. In one example the second melting point can be from 125° F. to 130° F., in another example at least 110° F., in another example at least 115° F., in another example at least 120° F. In another example, the second melting point can be at least 3° F. different than the first melting point; in another example at least 5° F. different; in another example at least 8° F. different; in another example at least 10° F. different; in another example at least 12° F.; and in another example at least 15° F. different. Accordingly, in one example, the second portion can provide rigidity to the supplement since the second melting point is greater than the first melting point. In one example, the melting point of the second portion can be greater than the melting point of the first portion. Melting point is measured according to AOCS Official Method Cc 1-25 entitled Melting Point Capillary Tube Method.

In one example, the second portion can be from 1 millimeter (mm) to 1 centimeter (cm) thick, in another example from 2 mm to 6 mm thick, in another example from 3 mm to 5 mm thick, and in another example from 2 mm to 4 mm thick.

The first portion and/or the second portion of the composition can comprise a colorant. In one example, the first portion and the second portion can be approximately the same color. In another example, the first portion and the second portion can be different colors. Alternatively, the first portion and the second portion can comprise more than one color. Non-limiting examples of colorants can include titanium dioxide, which can be used for a white color, stearine, which can be used for a white color, caramel, which can be used for brown, all natural colorants, and specific examples such as CSL 37542 Brown Dispersion OB, available from Sensient Colors of St. Louis, Mo.

In one example, each portion can comprise from 0.1% to 5%, by weight, colorant; in another example from 0.25% to 4%; and in another example, from 0.5% to 2%. In one example, the colorant can be a caramel colorant, a paprika colorant, or combinations thereof. In one example, the colorant can be aqueous based or non-aqueous based. In another example, the non-aqueous based colorant can be a fat based colorant, including natural or non-natural colorants. Non-aqueous fat based colorants can allow proper mixing to occur such that the color of the supplement and the portions of the supplement can be more uniform. It has been found that when using certain types of colorants, the color will not be uniform, which results in a layering or gradation of colors, rather than a smooth, uniform color.

The composition can contain one or more sensitive ingredients. The sensitive ingredient can be in the first portion, the second portion, or both the first portion and the second portion. In one example, the second portion is substantially free of a sensitive ingredient. In another example, the first portion comprises Probiotics. In another example, the second portion can be substantially free of Probiotics. In another example, the first portion comprises a sensitive ingredient and the second portion comprises a different sensitive ingredient. In one example, the composition can comprise more than one sensitive ingredient. In another example, a sensitive ingredient can be applied to the composition as a coating.

The compositions may comprise at least 0.1%, alternatively at least 0.5%, and alternatively at least 1% of the sensitive ingredient, by weight of the composition. As further examples, the compositions may comprise 99% or less, alternatively 75% or less, alternatively 50% or less, alternatively 25% or less, alternatively 10% or less, and alternatively 5% or less of the sensitive ingredient, by weight of the composition.

Non-limiting examples of sensitive ingredients can include Probiotics, vitamin ingredients, polyphenol ingredients, amino acid ingredients, carotenoid ingredients, antioxidant ingredients, fatty acid ingredients, glucose mimetic ingredients, chondro-protective agents, other sensitive ingredients, and combinations thereof.

In one example, the sensitive ingredient can be a Probiotic component. The Probiotic component may comprise one or more yeast or bacterial Probiotic microorganisms suitable for pet consumption and effective for maintaining or improving the microbial balance in the pet gastrointestinal tract or for another benefit, such as disease or condition relief or prophylaxis, to the pet.

In an example, strains of Bifidobacteria isolated from resected and washed canine or feline gastrointestinal tract can be used. Accordingly, various Probiotic microorganisms known in the art can be suitable for use in the present invention. See, for example, WO 03/075676, and U.S. Published Application No. US 2006/0228448A1. In other examples, the Probiotic can be selected from bacteria, yeast or microorganism of the genera Bacillus, Bacteroides, Bifidobacterium, Enterococcus (e.g., Enterococcus faecium DSM 10663 and Enterococcus faecium SF68), Lactobacillus, Leuconostroc, Saccharomyces, Candida, Streptococcus, and combinations thereof. In another example, the Probiotic can be selected from the genera Bifidobacterium, Lactobacillus, and combinations and mixtures thereof.

In one example, the Probiotic can form a spore, such as those from the genera Bacillus. In another example, the Probiotic does not form a spore. In another example, the Probiotic can be freeze-dried or lyophilized. Non-limiting examples of lactic acid bacteria suitable for use herein include strains of Streptococcus lactis, Streptococcus cremoris, Streptococcus diacetylactis, Streptococcus thermophilus, Lactobacillus bulgaricus, Lactobacillus acidophilus (e.g., Lactobacillus acidophilus strain DSM 13241), Lactobacillus helveticus, Lactobacillus bifidus, Lactobacillus casei, Lactobacillus lactis, Lactobacillus plantarum, Lactobacillus rhamnosus, Lactobacillus delbrukii, Lactobacillus thermophilus, Lactobacillus fermentii, Lactobacillus salvarius, Lactobacillus reuteri, Bifidobacterium longum, Bifidobacterium infantis, Bifidobacterium bifidum, Bifidobacterium animalis, Bifidobacterium pseudolongum, Pediococcus cerevisiae, and combinations and mixtures of any thereof. In another example, the Probiotic can comprise the bacterial strain Bifidobacterium animalis AHC7 NCIMB 41199. Other examples of the Probiotic can include one or more microorganisms identified in U.S. Published Application Nos. US 2005/0152884A1, US 2005/0158294A1, US 2005/0158293A1, US 2005/0175598A1, US 2006/0269634A1, US 2006/0270020A1, and PCT International Publication No. WO 2005/060707A2.

In one example, the compositions of the present invention can have a viable Probiotic microorganism count of at least 10⁵ colony forming units per gram (CFU/g) of composition, or at least 10⁶ CFU/g of composition, or at least 10⁸ CFU/g of composition, or at least 10⁹ CFU/g of composition. In another example, the composition may have a viable Probiotic microorganism count of up to 10¹⁴ CFU/g of composition, up to 10¹² CFU/g of composition, or up to 10¹⁰ CFU/g of composition, or up to 10⁹ CFU/g of composition. CFU is determined using the method provided as part of the European Pharmacopoeial Methods, 2003, Section 2.6.12.

Advantageously, the composition, containing a Probiotic sensitive ingredient, can have a shelf life of at least three months, alternatively at least six months, alternatively at least 12 months, alternatively at least 18 months, alternatively at least 24 months, alternatively from three months to 24 months, alternatively from six months to 18 months. As used herein, the term “shelf life” refers to that property of the composition whereby 1% or more, alternatively 5% or more, alternatively 10% or more, alternatively 25% or more, alternatively 50% or more, alternatively 75% or more, of the Probiotic microorganisms of the composition are live viable and active at the referenced time period after exposure to the shelf life conditions for a specified period of time. Shelf life conditions are ambient conditions at 71.6° F. with 35% relative humidity.

Non-limiting examples of vitamin ingredients can include choline chloride, vitamin E (tocopherols), ascorbic acid, vitamin A acetate, calcium pantothenate, pantothenic acid, biotin, thiamine mononitrate (source of vitamin B1), vitamin B12 supplement, niacin, riboflavin supplement (source of vitamin B2), inositol, pyridoxine hydrochloride (source of vitamin B6), vitamin D3 supplement, folic acid, vitamin C, ascorbic acid, and combinations thereof.

Non-limiting examples of polyphenols ingredients can include tea extract, rosemary extract, rosemarinic acid, coffee extract, caffeic acid, turmeric extract, blueberry extract, grape extract, grapeseed extract, and/or soy extract.

Non-limiting examples of amino acid ingredients can include 1-Tryptophan, Taurine, Histidine, Carnosine, Alanine, Cysteine, Arginine, Methionine, Tryptophan, Lysine, Asparagine, Aspartic acid, Phenylalanine, Valine, Threonine, Isoleucine, Histidine, Leucine, Glycine, Glutamine, Taurine, Tyrosine, Homocysteine, Ornithine, Citruline, Glutamic acid, Proline, peptides, Serine, and combinations thereof.

Non-limiting examples of carotenoid ingredients can include lutein, astaxanthin, zeaxanthin, bixin, lycopene, beta-carotene, and combinations thereof.

Non-limiting examples of antioxidant ingredients can include selenium, CoQ10 (Co-enzyme Q10), mixed tocopherols, and combinations thereof.

Non-limiting examples of fatty acid ingredients can include arachidonic acid, alpha-linoleic acid, gamma linolenic acid, linoleic acid, eicosapentanoic acid (EPA), docosahexanoic acid (DHA), fish oils as a source of EPA and/or DHA, and combinations thereof.

In one example, the composition can comprise a mixture of omega-3-fatty acids and omega-6-fatty acids, often through utilization of various materials containing these components. Certain compositions for use herein may be enriched in one or more specific omega-3-fatty acids or omega-6-fatty acids.

Non-limiting examples of glucose mimetic ingredients can include glucose anti-metabolites including 2-deoxy-D-glucose, 5-thio-D-glucose, 3-O-methylglucose, anhydrosugars including 1,5-anhydro-D-glucitol, 2,5-anhydro-D-glucitol, and 2,5-anhydro-D-mannitol, mannoheptulose, avocado extract comprising mannoheptulose, and combinations thereof.

In one example, mannoheptulose can be present at 0.1% to 10%, by weight of the supplement. In another example, mannoheptulose can be present at 0.1% to 5%, by weight of the supplement. In other examples, mannoheptulose can be present at 0.1% to 4%, by weight of the supplement. In other example, mannoheptulose can be present at 0.1% to 3%, by weight of the supplement. In another example, mannoheptulose can be present at 1% to 5%, by weight of the supplement. In another example, mannoheptulose can be present at 1% to 4%, by weight of the supplement. In one example, mannoheputlose can be present at 2%, by weight of the supplement.

Non-limiting examples of chondro-protective agents can include MSM (methylsulfonylmethane), glucosamine hydrochloride, chondroitin sulfate, Perna canaliculus, and combinations thereof.

Suitable other sensitive ingredients can include biologics, for example, but not limited to, biologics selected from the group consisting of enzymes, antibodies, immunoglobulins, cytokines, epigenetic agents, and mixtures and combinations of these.

The compositions herein can comprise a sweetener. The sweetener can comprise a monosaccharide, disaccharide, or any mixture thereof. The first portion and/or the second portion can comprise a sweetener component and/or mixtures of sweetener components.

In one example, the compositions herein comprise a monosaccharide. The monosaccharide utilized herein is of the general formula CₙH₂ₙOₙ, wherein n is an integer equal to or greater than 3. Non-limiting examples of monosaccharides that may be used include sorbitol, mannitol, erythrose, threose, ribose, arabinose, xylose, ribulose, glucose, galactose, mannose, fructose, sorbose, and any mixture thereof. In one example, the monosaccharide may include sorbitol, mannitol, glucose, mannose, fructose, or any mixture thereof. In another example, the monosaccharide is sorbitol.

In one example, the compositions herein comprise a disaccharide. The disaccharide utilized herein is of the general formula CₙH₂ₙ₋₂Oₙ₋₁, wherein the disaccharide has 2 monosaccharide units connected via a glycosidic bond. In such formula, n is an integer equal to or greater than 3. Non-limiting examples of disaccharides that may be utilized herein include sucrose, maltose, lactitol, maltitol, maltulose, lactose, and any mixture thereof. In another example, the monosaccharide is sucrose.

In one example, which may be particularly advantageous if the sensitive ingredient is a Probiotic, the sweetener component can comprise a monosaccharide or disaccharide that has a melting point of from 180° F. to 280° F., or from 200° F. to 250° F. Non-limiting examples include monosaccharides, such as sorbitol or xylitol.

The composition can comprise a sweetener component. The sweetener components can be a source of sweeteners as well as other components. An example of a sweetener component is white creamy coating which is commercially available from the Blommer Chocolate Company of Chicago, Ill., and is commercially known as Blommer Creamy White Coating. The Blommer Creamy White Coating comprises a confectioner's white coating made from a blend of sugar, vegetable oils, nonfat milk powder, lecithin, and artificial color and flavor. More specifically, the Blommer Creamy White Coating comprises sugar, partially hydrogenated palm kernel oil, nonfat milk powder, soy lecithin added as an emulsifier, monoglycerides, artificial color in the form of titanium dioxide, and artificial flavor. The Blommer Creamy White Coating is generally a complete crystalline solid at 40° F. and begins crystallizing at 64° F. It begins melting at 73° F. and is in complete liquid phase at 104° F. Other similar creamy white coatings are available from other manufacturers other than Blommer and can be used as well.

The compositions can comprise a fat. Sources of fat are widely known, and as used herein are interpreted to include (as examples) wax, fat, fatty acid, and/or lipid.

Specific examples of wax, fat, fatty acid, or lipid may often be interchangeable in accordance with nomenclature common in the art; for example, a lipid may often also be characterized as a fat. The inventors herein do not intend to be limited by any particular designation of nomenclature, and classifications of a particular material as a wax, fat, fatty acid, lipid, or the like is made for purposes of convenience only.

Non-limiting examples of fat can include cocoa butter, palm kernel oil, palm oil, cottonseed oil, soybean oil, canola oil, rapeseed oil, peanut oil, butter oil, hydrogenated and partially hydrogenated derivatives of oils and fats (including those listed herein), wax, paraffin, paraffin wax, paraffin oil, liquid paraffin, solid paraffin, candelilla wax, carnauba wax, microcrystalline wax, beeswax, long chain fatty acids and esters thereof, capric acid, myristic acid, palmitic acid, stearic acid, oleic acid, lauric acid, behenic acid, adipic acid, acetyl acyl glycerols, acetylated monoglyceride, dewaxed gumlac, triolein, chocolate, chocolate liquor, sweet milk chocolate, cocoa solids, methylcellulose, hydroxypropylmethylcellulose, glycerol monostearate, polyethylene glycol, stearyl alcohol, cetyl alcohol, behenyl alcohol, olestra, tristearin, animal fat, poultry fat, and combinations thereof.

In other examples, the fat can include one or more partially hydrogenated plant oils or plant oils high in saturated fats (i.e., plant oil that is substantially solid at room temperature). Additionally, it has been found that partially hydrogenated plant oil, such as soybean oil, corn oil, cottonseed oil, cocoa butter, palm kernel oil, palm oil, canola oil, rapeseed oil, peanut oil, butter oil, and the like (including oil mixtures), may reduce transmission of water, oxygen or degradation processes, such as oxidation or other processes that compromise the sensitive ingredients.

Suitable examples of higher melting point temperature components, such as high melting point fats, which can be used as ingredients include, but are not limited to, waxes such as, but not limited to, candelilla wax, carnauba wax, microcrystalline wax, and bees wax; fatty acids and esters thereof such as, but not limited to, capric acid, lauric acid, myristic acid, palmitic acid, stearic acid, oleic acid, and behenic acid; hydrogenated oils and fats, such as, but not limited to, hydrogenated soybean oil, hydrogenated cottonseed oil, hydrogenated palm oil, hydrogenated peanut oil, hydrogenated rapeseed oil, hydrogenated corn oil, hydrogenated poultry fat, hydrogenated tallow, hydrogenated lard, and hydrogenated fish oil; partial glycerides of hydrogenated fats and oils, such as, but not limited to all those listed herein; fatty alcohols, such as, but not limited to, cetyl alcohol, stearyl alcohol, and behenyl alcohol; and combinations of any thereof. In certain embodiments, the fat component can have a melting point ranging from 75° F. to 160° F., or in certain embodiments ranging from 110° F. to 160° F.

The fat can comprise a cocoa butter component. As defined herein the cocoa butter component comprises one or more of cocoa butter, a cocoa butter extender, a cocoa butter replacer, or a cocoa butter substitute. A given fat may be classified as one of a cocoa butter extender, cocoa butter replacer, or cocoa butter substitute, or sometimes may be classified as two or more of a cocoa butter extender, cocoa butter replacer, and cocoa butter substitute. Where used, each of the cocoa butter extender, cocoa butter replacer, and cocoa butter substitute may be one particular fat within the referenced class or any mixtures of such fats.

Cocoa butter is commonly known in the art and may generally refer to the fat from cocoa beans used to prepare chocolate. Cocoa beans are obtainable from the pods of cocoa trees (e.g., Theobroma cocoa). Cocoa butter is commercially available from the Blommer Chocolate Company of Chicago, Ill. An example of a cocoa butter available from Blommer comprises their standard cocoa butter. This cocoa butter can be a prime pressed cocoa butter that has been mechanically pressed from properly roasted, winnowed, and milled blended chocolate liquor. Subsequent to pressing, the cocoa butter can be centrifuged to remove any remaining solids. The cocoa butter flavor can then be free from any off odors or off notes. The melting point can be around 85° F. to 95° F. Furthermore, the water activity of the cocoa butter can be below the required water activity levels to support the growth of microorganisms.

The cocoa butter component may additionally or alternatively comprise a cocoa butter extender. These extenders are also commonly known in the art, and may generally refer to other fats having solid fat index (SFI) profiles which are similar to cocoa butter. Cocoa butter extenders may comprise fat containing C₁₆ or C₁₈ fatty acids, or combinations thereof. Palm oil, shea oil, illipe butter, mango butter, sal butter, cottonseed oil, and soybean oil, including fractionated and/or partially hydrogenated forms, are non-limiting examples of cocoa butter extenders.

The cocoa butter component may additionally or alternatively comprise a cocoa butter replacer. These replacers will also be commonly known in the art, and may generally refer to fats having melting or other properties, or structures, similar to those of cocoa butter, which are based on non-lauric fats (e.g., C₁₆ or C₁₈). These include vegetable oils such as palm oil, cottonseed oil, soybean oil, and rapeseed oil, including fractions and/or partially hydrogenated forms thereof. One example is ASTRAI® (partially hydrogenated vegetable oil (soybean oil and cottonseed oil), commercially available from Humko Oil Products, Cordova, Tenn.).

The cocoa butter component may additionally or alternatively comprise a cocoa butter substitute. These substitutes will also be commonly known in the art, and may generally refer to hard fats having melting or other properties, or structures, similar to those of cocoa butter, but which are based on lauric fats (C₁₂). Such cocoa butter substitutes may tend to have melting points higher than that of cocoa butter, making these substitutes interesting for imparting heat resistance to compositions. These include vegetable oils such as palm kernel oil and coconut oil, including fractions and/or partially hydrogenated forms thereof.

In one embodiment, the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

Alternatively or additionally, the fat may comprise an animal-derived fat component. As will be commonly known in the art, the animal-derived fat component comprises a fat derived from an animal. Non-limiting examples include beef, poultry, pork, and lamb (e.g., lards and tallows). Dairy fats may also be examples, including milkfat, fractionated milkfat, and butterfat.

In one example, the fat may comprise a combination of a cocoa butter component and an animal-derived fat component at a ratio of from 5:95 to 95:5, or from 5:95 to 25:75, or from 5:95 to 50:50, all by weight. In another embodiment herein, the fat comprises the cocoa butter component and the animal-derived fat component at a ratio of from 20:80 to 45:55, or from 25:75 to 40:60, all by weight.

The present composition may optionally comprise one or more optional components. The optional component can be in the first portion, the second portion, or both the first and second portions. The optional components can also be a coating applied to the composition, the first portion, or the second portion. Non-limiting examples of optional components can include crude protein, shellac, chitin, chitosan, alginate, dairy by-products, and combinations thereof.

In one embodiment, the compositions may comprise, on a dry matter basis, from 0.1% to 30% crude protein, or from 1% to 20% crude protein, by weight of the composition. The crude protein material may comprise any material having a protein content of at least 15% by weight, non-limiting examples of which include vegetable proteins such as soybean, cottonseed, and peanut, animal proteins such as casein, albumin, chicken, beef, pork, lamb, turkey, poultry meat tissue, and combinations thereof. Non-limiting examples of meat tissue useful herein include fresh meat, and dried or rendered meals such as fish meal, poultry meal, meat meal, bone meal, and the like. Other types of suitable crude protein sources include wheat gluten or corn gluten, and proteins extracted from microbial sources such as yeast.

The compositions can comprise dairy by-products such as dried whey.

### Processing

The compositions of the present invention can be made by any suitable method. In one example, the compositions are not extruded.

One example of a process for making the composition in accordance with the compositions disclosed above is described hereinafter.

The first portion can be made as follows. Cocoa butter can be heated to 130° F. for at least eight hours, or even longer. Heating the cocoa butter can help remove residual water that can compromise the sensitive ingredient. After heating, the cocoa butter will be melted. Then, the cocoa butter can be cooled to 110° F. This cooling step can reduce compromising the sensitive ingredient when it is added to the cocoa butter. The sensitive ingredient, which can be a Probiotic, is added and the composition is mixed. In one example, the composition is mixed using a static mixer. Once the mixture is mostly, if not completely, homogeneous and the sensitive ingredient is saturated or fully coated with the cocoa butter, the sweetener, which can be a sweetener component such as creamy white coating, can be added. The sweetener can be held at 105° F. for around 24 hours or more prior to mixing it with the cocoa butter and sensitive ingredient mixture. This mixing can be maintained at around 100 to 105° F. Then, color can optionally be added, and the mixture can be mixed until it is homogenous.

The second portion can be made as follows. Sugar, such as 6× sugar, is put in a bowl of a mixer, such as a Hobart mixer. The bowl and the paddle can be pre-warmed so they are both greater than 100° F. A separate mixture is made with a higher melting point fat, such as K.L.X.™, which is heated to above 135° F., and lecithin. Lecithin is not always used but can be a processing aid that makes the mixture flow better. The fat and lecithin mixture is then added to the sugar and mixed at the lowest speed until there are no clumps, which generally takes 5 to 10 minutes. Then color can optionally be added to the mixture. The fat, lecithin, sugar, color mixture is mixed thoroughly at the lowest speed until it is smooth. The mixture should be continuously stirred slowly to ensure that the mixture is uniform until it is added to the first portion to form the composition.

The first portion can be added to a blister package, as described in more detail hereafter. The blister package can have one or more enclosures which can serve as molds for the mixtures. In one example, approximately 1.5 grams of the first portion is added to each enclosure. At this point the first portion can be approximately 100° F.

Then, the first portion can be cooled. This first cooling step is optional. The first cooling step can be advantageous by producing a smoother composition. Any method of cooling can be used. In one example, the cooling process can occur through a cooling tunnel that is around 60° F. The composition can be in the cooling tunnel for seven to twelve minutes. Of course, cooling can be completed at other temperatures and times, and such temperatures and times are dependent on one another. For example, cooling can be done at around 50° F., or even below 50° F., for around five to ten minutes. During cooling, the mixture will harden and crystallize while in the enclosure mold to form a solid first portion. Next, the second portion can be added to the first portion. In one example, 0.5 grams of the second portion is added on top of the first portion. The entire composition is then cooled by any method, including the cooling tunnel as described above. At this point, a blister pack with enclosures filled with compositions has been manufactured. In one example, the compositions are pet food supplements. Once sealed, the blister pack can then be inserted into a secondary container or package, the configuration of which is described hereinafter in more detail.

The above processing allows consistent and controllable dosing through the supplement. By sufficient and homogenous mixing of the multiple components, a controllable amount of a sensitive ingredient can be provided in a single supplement and results in an end product that can provide a predictable unit dose of a sensitive ingredient.

### Packaging

The compositions of the present invention can be packaged and sealed in any suitable packaging. The packaging can help protect the compositions and the sensitive ingredients from excessive heat and moisture. Additionally, in some examples it is important that the packaging does not absorb fat from the compositions. In one example, the sensitive ingredient can have heat sensitization properties. Those properties can result in requiring packaging that has the ability to be cold shipped, such as at temperatures less than 75° F. These factors can be important in determining the types of components used in the packaging of the compositions of the present invention.

In one example, the packaging can comprise a primary container, the primary container can have at least one enclosure, the enclosure can contain at least one dosage unit or supplement, and the dosage unit or supplement can comprise a sensitive ingredient. In one example, the sensitive ingredient is a Probiotic. The primary container can be a blister pack as would be understood and commonly used in the art. The primary container can be of varying shape and size based upon the number, size, and type of supplement contained therein and can be sized to be conveniently portable. Non-limiting examples of such shapes include round, oval, rectangular, square, triangular, trapezoidal, hexagonal, octagonal, paw print, and combinations thereof as disclosed for example, in D605,527, D651,524, D631,757, D640,564, and D651,095. The shapes can include other indicia, such as words, numbers images, images of species, age of the intended user of the product, brand names, trade dress features, and the like. The primary container can also be formed to have means to permit separation of one or more portions of the primary container, i.e. one or more portions containing an enclosure. As would be understood by those of skill in the art, non-limiting examples of such means include perforations, scoring and combinations thereof.

As would be understood by those skilled in the packaging arts, to include structure and making of packaging, a blister pack can include one or more blister layers and a rupturable layer, the combination of which encloses one or more supplements. Thus, the blister layer can provide enclosures, in any suitable size and/or shape, for one or more supplements of any suitable size, shape, or form. The supplement can take the shape of the enclosure and the enclosure can be a mold for the composition.

The rupturable layer permits the supplement to be removed from the blister pack. The rupturable layer can be formed over all or a portion of the blister layer. Such blister packs can also comprise a backing layer that can be disposed on or over the rupturable layer to prevent unintended rupture and release of dosage units. Such backing layer can be peeled away to expose the rupturable layer when release of a supplement is desired. Such backing layer can be formed over all or a portion of the rupturable layer. Such a backing layer can be affixed to the rupturable layer and/or the blister layer via, for example, adhesive.

Blister layers can be made from a variety of suitable materials, non-limiting examples of which include polyvinyl chloride, thermoplastic materials, polyolefins, and combinations thereof. The blister layer can be opaque, partially opaque, or transparent, and can be colorless or colored.

Rupturable layers can be made from a variety of suitable materials, non-limiting examples of which include metal foil, tempered metal foil, paperboard, polyvinyl chloride, polyolefins, polystyrenes, polyesters, fluoropolymer resins, and combinations thereof. The rupturable layer can also be formed as a laminate composed of a plurality of laminated layers of different materials, so long as its basic operation and rupturability is not affected. The rupturable layer can be of any desired color.

Backing layers can be made from a variety of suitable materials, non-limiting examples of which include paper, plastic, polyvinyl chloride, and combinations thereof. The backing layer can be of any desired color.

In one example, the first portion and/or the second portion is a liquid when it is placed into the enclosure. The liquid composition can solidify in the enclosure, thus taking the shape of the enclosure. In certain examples, the composition may be smaller than the enclosure. It may be necessary to have a mechanical structure, such as a frill, to prevent the composition from jostling around and getting damaged. The frill could also help remove the supplement without deforming it.

The packaging for the pet food composition can also optionally include a secondary container. A secondary container can contain one or more separate, discrete primary containers and/or can be formed as an integrated structure with the primary container. The secondary container can be of varying shape, size and form as desired based upon the number, size and type of primary containers contained therein and/or formed as a part thereof, and can be sized to be conveniently portable. Non-limiting examples of such shapes and forms include round, oval, rectangular, square, triangular, trapezoidal, octagonal, foldable and combinations thereof. Non-limiting examples of secondary containers can include boxes and cartons. Non-limiting examples of integrated primary and secondary containers include tri-fold structures in which a primary container is affixed to a secondary container that folds over one or more portions of the primary container; and structures shaped and structured similarly to a book in which one or more primary structures form page-like structures bound within a secondary container outer covering forming an integrated structure. The primary and secondary containers can also be separate, discrete elements, and one or more primary containers can be removed from the secondary container. The secondary container can be made from a variety of materials, non-limiting examples of which include paper, paperboard, cardboard, plastic, and combinations thereof.

Additional packaging options are envisioned. Some of those packaging options are disclosed, for example, in United States Publication No. 2010/0003368.

### EXAMPLE1

Pet supplements were made according to the processing method as described herein. Each supplement contained approximately between 10⁹ and 10¹⁰ CFU of Probiotic microorganism and weighed approximately 2.6 grams. The supplements were made in a 5000 grams batch process. Approximately 500 grams of Probiotic microorganisms were mixed with about 170 grams of cocoa butter. This mixture was added to about 1000 grams of Blommer creamy white coating, which was then mixed with about 3330 grams of additional Blommer creamy white coating, forming the final mixture. This final mixture was deposited in the enclosures of the blister package. Then, the second portion was added. The second-second portion included about 325 grams of K.L.X.™ fat, about 500 grams of 6× sugar, and 3.0 grams of natural caramel color. The first-second portion was liquid and was added on top of the final mixture that was deposited in the enclosures. The second-second portion was liquid and was added on top of the first-second portion. The supplements were placed in a cooling area to solidify. The cooling time and temperature can vary. For instance, the supplements can be cooled for about 10 minutes at about 45° F. or about 30 minutes at about 70° F.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising:
a. from 45% to 90%, by weight, of a first portion wherein the first portion comprises a sensitive ingredient and wherein the first portion has a first melting point; and
b. from 10% to 55%, by weight, of a second portion wherein the second portion has a second melting point and wherein the second melting point is greater than the first melting point.

2. The composition of claim 1 comprising from 60% to 80%, by weight, first portion and from 20% to 40%, by weight, second portion.

3. The composition of claim 1 wherein the first portion further comprises a fat and a sweetener.

4. The composition of claim 3 wherein the fat is a cocoa butter component.

5. The composition of claim 1 wherein the second portion further comprises a fat.

6. The composition of claim 5 wherein the fat is partially hydrogenated vegetable oil.

7. The composition of claim 6 wherein the second portion further comprises a sweetener.

8. The composition of claim 1 wherein the second portion is substantially free of a sensitive ingredient.

9. The composition of claim 1 wherein the second melting point is at least 3° F. greater than the first melting point.

10. The composition of claim 1 wherein the second melting point is at least 5° F. greater than the first melting point.

11. The composition of claim 1 wherein the first melting point is at least 85° F. and wherein the second melting point is at least 110° F.

12. The composition of claim 1 wherein the first portion has a water activity from 0.1 to 0.4.

13. The composition of claim 1 wherein the second portion covers from 10% to 50% of a surface of the first portion.

14. The composition of claim 1 wherein the first portion is adjacent to the second portion.

15. The composition of claim 1 wherein the composition is a supplement for pets.

16. The composition of claim 1 wherein the sensitive ingredient is a Probiotic.

17. The composition of claim 16 wherein the first portion comprises greater than 10⁵ CFUs/g of the composition.

18. The composition of claim 16 further comprising a second sensitive ingredient.

19. The composition of claim 16 wherein the second portion is substantially free of a Probiotic.

20. The composition of claim 1 wherein the composition is enclosed within a blister package.
